(19) United States
(12) Patent Application Publication
(10) Pub. No.: US 2024/0026644 A1
(43) Pub. Date: Jan. 25, 2024

(54) SYSTEM AND METHOD FOR IDENTIFYING OBSTACLES ENCOUNTERED BY A WORK VEHICLE WITHIN A WORK SITE

(71) Applicant: CNH Industrial America LLC, New Holland, PA (US)

(72) Inventor: Scott A. Elkins, Homer Glen, IL (US)

(21) Appl. No.: 17/868,280

(22) Filed: Jul. 19, 2022

(51) Int. Cl. E02F 9/20; G05D 1/02; G05D 1/00

(52) U.S. Cl. CPC E02F 9/205; G05D 1/0274; G05D 1/0238; G05D 1/0061; G05D 1/0044; G05D 1/0246; G05D 2201/0202

(57) ABSTRACT

A work vehicle includes a computing system configured to access a map associated with a work site. Additionally, the computing system is configured to control the operation of the work vehicle based on the map such that an earthmoving operation is performed on the work site. Moreover, the computing system is configured to monitor an operating parameter of the work vehicle as the earthmoving operation is being performed based on received operating parameter sensor data. In addition, the computing system is configured to determine when the work vehicle has encountered an obstacle based on the monitored operating parameter. Furthermore, when the work vehicle has encountered the obstacle, the computing system is configured to update the map to identify the location of the obstacle within the work site on the map.

### FIELD OF THE INVENTION

The present disclosure generally relates to work vehicles and, more particularly, to systems and methods for identifying obstacles encountered by a work vehicle within a work site.

### BACKGROUND OF THE INVENTION

Work vehicles, such as motor graders, are used in many aspects of road construction and maintenance. For example, motor graders can be used for moving material when shaping the surface of a road, such as from high spots to low spots. As such, a motor grader typically includes an earthmoving implement, such a moldboard or other blade. In this respect, as the motor grader travels across a surface, the earthmoving implement is configured to move a quantity of material, such as soil, gravel, and/or the like.

During an earthmoving operation, the work vehicle may encounter various obstacles within the work site, such as rocks, mud or other wet soil, holes, or divots, and/or the like. Such obstacles may interfere with the operation of the work vehicle that has encountered the obstacle. Moreover, such obstacles may further interfere with the operation of other work vehicles moving within the work site. As such, systems for identifying obstacles within a work site have been developed. While such systems work well, further improvements are needed.

Accordingly, an improved system and method for identifying obstacles encountered by a work vehicle within a work site would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a work vehicle including a frame and an earthmoving implement supported on the frame, with the earthmoving implement configured to move material as the work vehicle travels across a surface within a work site. Furthermore, the work vehicle includes an operating parameter sensor configured to generate operating parameter data indicative of an operating parameter of the work vehicle and a computing system communicatively coupled to the operating parameter sensor. The computing system is configured to access a map associated with the work site. Additionally, the computing system is configured to control an operation of the work vehicle based on the map such that an earthmoving operation is performed on the work site. Moreover, the computing system is configured to monitor the operating parameter of the work vehicle as the earthmoving operation is being performed based on the operating parameter data generated by the operating parameter sensor. In addition, the computing system is configured to determine when the work vehicle has encountered an obstacle based on the monitored operating parameter. Furthermore, when the work vehicle has encountered the obstacle, the computing system is configured to update the map to identify a location of the obstacle within the work site on the map.

In another aspect, the present subject matter is directed to a system for identifying obstacles encountered by a work vehicle within a work site. The system includes an operating parameter sensor configured to generate operating parameter data indicative of an operating parameter of the work vehicle and a computing system communicatively coupled to the operating parameter sensor. The computing system is configured to access a map associated with the work site, with the map depicting a material flow for transforming a current grade of the surface into a target grade of the surface. Additionally, the computing system is configured to control an operation of the work vehicle based on the map such that an earthmoving operation is performed on the work site. Moreover, the computing system is configured to monitor the operating parameter of the work vehicle as the earthmoving operation is being performed based on the operating parameter data generated by the operating parameter sensor. In addition, the computing system is configured to determine when the work vehicle has encountered an obstacle based on the monitored operating parameter. Furthermore, when the work vehicle has encountered the obstacle, the computing system is configured to update the map to identify a location of the obstacle within the work site on the map.

In a further aspect, the present subject matter is directed to a method for identifying obstacles encountered by a work vehicle within a work site. The method includes accessing, with a computing system, a map associated with the work site, with the map depicting a material flow for transforming a current grade of a surface of the work site into a target grade of the surface. Additionally, the method includes controlling, with the computing system, an operation of the work vehicle based on the map such that an earthmoving operation is performed on the work site. Moreover, the method includes receiving, with the computing system, operating parameter sensor data indicative of an operating parameter of the work vehicle as the earthmoving operation is being performed. In addition, the method includes monitoring, with the computing system, the operating parameter of the work vehicle based on the received operating parameter data. Furthermore, the method includes determining, with the computing system, when the work vehicle has encountered an obstacle based on the monitored operating parameter. In addition, when the work vehicle has encountered the obstacle, the method includes updating, with the computing system, the map to identify a location of the obstacle within the work site on the map.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a side view of one embodiment of a work vehicle in accordance with aspects of the present subject matter;

FIG. 2 illustrates a top view of the work vehicle shown in FIG. 1;

FIG. 3 illustrates a schematic view of one embodiment of a system for identifying obstacles encountered by a work vehicle within a work site in accordance with aspects of the present subject matter;

FIG. 4 illustrates a flow diagram providing one embodiment of control logic for identifying obstacles encountered by a work vehicle within a work site in accordance with aspects of the present subject matter; and

FIG. 5 illustrates a flow diagram of one embodiment of a method for identifying obstacles encountered by a work vehicle within a work site in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a system and a method for identifying obstacles encountered by a work vehicle within a work site. As will be described below, a computing system of the disclosed system is configured to access a map associated with the work site. For example, in some embodiments, the accessed cut-fill map may be a cut-fill map depicting the material flow for transforming the current grade(s) of one or more surfaces within the work site into a target grade(s) of such surface(s). In this respect, the computing system is configured to control the operation of the work vehicle (e.g., its engine, transmission, steering actuator, earthmoving implement actuator(s), etc.) based on the accessed map such that an earthmoving operation is performed on the work site.

In several embodiments, the computing system is configured to identify and map obstacles within the work site. More specifically, as the earthmoving operation is being performed, the computing system is configured to monitor one or more operating parameters of the work vehicle. Such operating parameter(s) may include engine torque, transmission torque, wheel speed, vehicle orientation (e.g., pitch), earthmoving implement force, manual operator adjustment/override, and/or the like. Furthermore, the computing system is configured to determine when the work vehicle has encountered an obstacle based on the monitored operating parameter(s). For example, when the monitored operating parameter(s) falls outside of an associated range(s), the computing system may determine that the work vehicle has encountered an obstacle. Thereafter, when the work vehicle has encountered an obstacle, the computing system is configured to update the map to identify the location of the obstacle within the work site on the map. For example, the computing system may add a warning indicator (e.g., an icon) to the map at the location that the work vehicle encountered the obstacle.

Identifying and mapping obstacles within a work site based on an operating parameter(s) of a work vehicle improves the operation of the work vehicle and the efficiency of the earthmoving operation. Many conventional systems rely on the operator of the work vehicle to identify and input when the work vehicle has encountered an obstacle. This can distract the operator and make it more difficult for him/her to perform the earthmoving operation. Other systems rely on cameras to identify obstacles within the work site. However, the use of camera or image data to identify obstacles is computationally expensive and requires significant computing resources, which are limited on the work vehicle. Conversely, the disclosed system and method rely on operating parameter data (e.g., engine torque, transmission torque, wheel speed, vehicle orientation, earthmoving implement force, manual operator adjustment/override, etc.) to identify obstacles. The use of such operating parameter data to identify obstacles is much more computationally simple and, thus, requires significantly fewer computing resources, thereby improving the operation of the work vehicle.

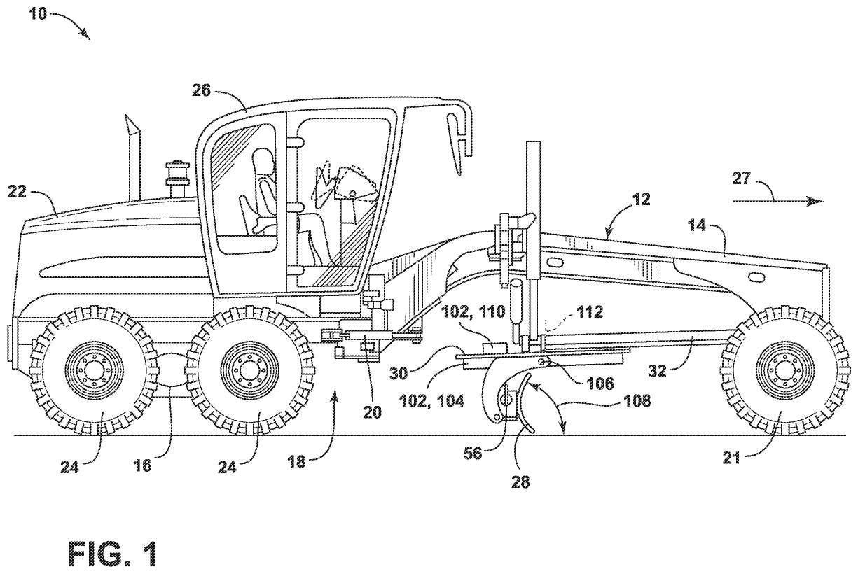

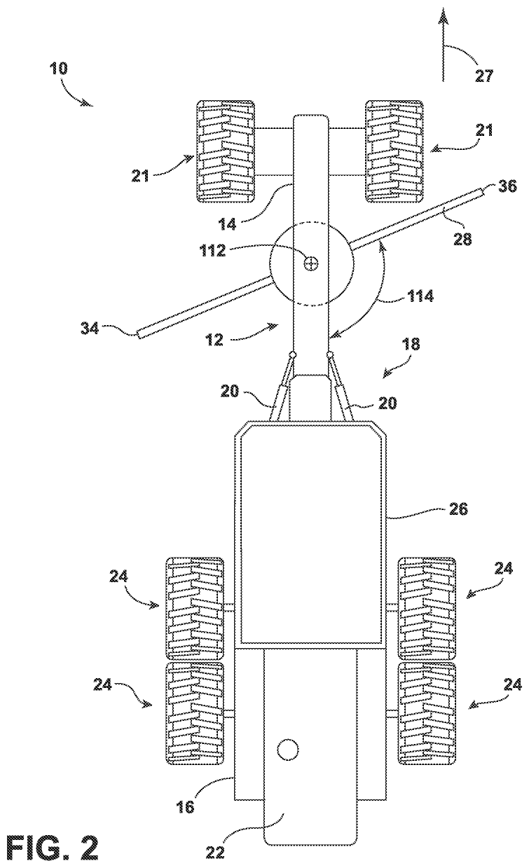

Referring now to the drawings, FIGS. 1 and 2 illustrate various views of one embodiment of a work vehicle 10. Specifically, FIG. 1 illustrates a side view of the work vehicle 10 and FIG. 2 illustrates a top view of the work vehicle 10. As shown, in the illustrated embodiment, the work vehicle 10 is configured as a motor grader. However, in alternative embodiments, the work vehicle 10 may be configured as any other suitable type of work vehicle, such as any suitable type of construction vehicle.

In general, the work vehicle 10 includes a frame 12 configured to support or couple to a plurality of components. Specifically, in several embodiments, the frame 12 may articulable. In such embodiments, the frame 12 includes a front frame portion 14 and a rear frame portion 16 pivotably coupled to the front frame portion 14 via an articulating joint 18. In this respect, the front frame portion 14 and the rear frame portion 16 may be configured to articulate or otherwise move relative to each other. Thus, the front frame portion 14 and the rear frame portion 16 can be oriented at various angular relationships relative to each other. For example, in some embodiments, one or more articulating adjustment actuators 20 may be supported on the frame 12 for adjusting the articulation of the work vehicle 10. Furthermore, as shown, a pair of non-driven, front wheels 21 may be coupled to the front frame portion 14. Moreover, the rear frame portion 16 may support an engine 22 configured to provide power for driving a tandem set of rear wheels 24 supporting the rear frame portion 16. Furthermore, the rear frame portion 16 may support an operator's cab 26 configured to provide an operating environment for the operator.

Additionally, the work vehicle 10 includes an earthmoving implement 28 supported on the frame 12. In general, the earthmoving implement 28 is configured to move material as the work vehicle 10 moves in a direction of travel 27 across a surface within a work site. Specifically, in several embodiments, the earthmoving implement 28 may be supported on the front frame portion 14. In such embodiments, the earthmoving implement 28 may be coupled to a plate gear 30, which is coupled to a drawbar 32. The drawbar 32 is, in turn, supported on the front frame portion 14. In this respect, and as will be described below, the earthmoving implement 28 is moveable relative to the front frame portion 14. As such, by moving the earthmoving implement 28 relative to the front frame portion 14, the manner in which the earthmoving implement 28 moves material relative to the surface (e.g., carrying material, spreading material, etc.) can be adjusted. Furthermore, in the illustrated embodiment, the earthmoving implement 28 is configured as a moldboard. Thus, the earthmoving implement 28 may extend in a lengthwise direction between a first end 34 (FIG. 2) and a second end 36 (FIG. 2). However, in alternative embodiments, the earthmoving implement 28 may be configured as any other suitable type of implement, such as a blade. In addition, the earthmoving implement 28 may be coupled to the frame 12 in any other suitable manner.

Furthermore, as shown in FIGS. 1 and 2, the work vehicle 10 may include one or more actuators 102. In general, the actuator(s) 102 is configured to adjust the position of the earthmoving implement 28 relative to the frame 12. For example, in several embodiments, the actuator(s) 102 may include one or more pitch actuator(s) 104. The pitch actuator(s) 104 is, in turn, configured to rotate the earthmoving implement 28 about a pitch axis 106 (FIG. 1) to adjust a pitch angle (e.g., as indicated by arrow 108 in FIG. 1) of the earthmoving implement 28. As shown, the pitch angle 108 generally corresponds to the angle between the earthmoving implement 28 and surface across which the work vehicle 10 is traveling. Additionally, in several embodiments, the actuator(s) 102 may include one or more rotational actuator(s) 110. The rotational actuator(s) 110 is, in turn, configured to rotate the earthmoving implement 28 about a rotational axis 112 (FIG. 2) to adjust a rotational angle (e.g., as indicated by arrow 114 in FIG. 2) of the earthmoving implement 28. As shown, the rotational angle 114 generally corresponds to the angle between the earthmoving implement 28 and frame 12 or the direction of travel 27. However, in alternative embodiments, the actuator(s) 102 may include any other suitable actuator(s) in addition to or in lieu of the actuators 104, 110. In addition, the actuator(s) 102 may be configured to move the earthmoving implement 28 relative to the frame 12 in any other suitable manner.

Moreover, the actuator(s) 102 may correspond to any suitable device(s) configured to move the earthmoving implement 28 relative to the frame 12. For example, the actuator(s) 102 may be configured as fluid-driven cylinder, electric linear actuators, or the like.

It should be further appreciated that the configuration of the work vehicle described above and shown in FIGS. 1 and 2 is provided only to place the present subject matter in an exemplary field of use. Thus, it should be appreciated that the present subject matter may be readily adaptable to any manner of work vehicle configuration.

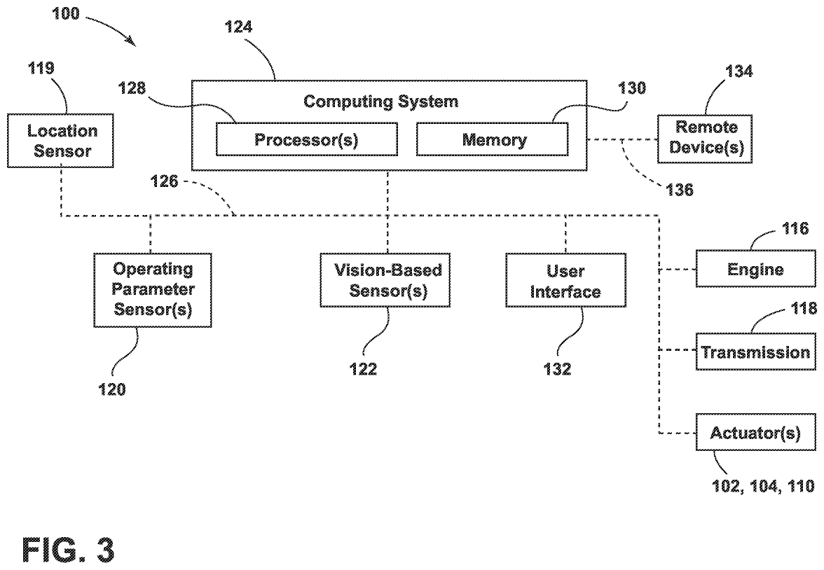

Referring now to FIG. 3, a schematic view of one embodiment of a system 100 for identifying obstacles encountered by a work vehicle within a work site is illustrated in accordance with aspects of the present subject matter. In general, the system 100 will be described herein with reference to the work vehicle 10 described above with reference to FIGS. 1 and 2. However, it should be appreciated by those of ordinary skill in the art that the disclosed system 100 may generally be utilized with work vehicles having any other suitable vehicle configuration.

As shown in FIG. 3, the system 100 may include one or more devices of the work vehicle 10 that are configured to adjust the ground speed at which the work vehicle 10 is traveling across the work site. For example, the system 100 may include an engine 116 and a transmission 118 of the work vehicle 10. In general, the engine 116 may be configured to generate power by combusting or otherwise burning a mixture of air and fuel. The transmission 118 may, in turn, be operably coupled to the engine 116 and may provide variably adjusted gear ratios for transferring the power generated by the engine to the rear wheels 24. For example, increasing the power output by the engine 116 (e.g., by increasing the fuel flow to the engine 116) and/or shifting the transmission 118 into a higher gear may increase the ground speed at which the work vehicle 10 moves across the work site. Conversely, decreasing the power output by the engine 116 (e.g., by decreasing the fuel flow to the engine 116) and/or shifting the transmission 118 into a lower gear may decrease the ground speed at which the work vehicle 10 moves across the work site. In some embodiments, the system 100 may include other devices of the work vehicle 10, such as a steering actuator (not shown).

Furthermore, the system 100 includes a location sensor 119 provided in operative association with the work vehicle 10. In general, the location sensor 119 may be configured to determine the current location of the work vehicle 10 using a satellite navigation positioning system (e.g., a GPS system, a Galileo positioning system, the Global Navigation satellite system (GLONASS), the BeiDou Satellite Navigation and Positioning system, and/or the like). In this respect, the location determined by the location sensor 119 may be transmitted to a computing system of the work vehicle 10 (e.g., in the form coordinates) and stored within the computing system's memory for subsequent processing and/or analysis. For instance, the determined location from the location sensor 119 may be used to geo-locate the work vehicle 10 within the work site.

Additionally, the system 100 includes one or more operating parameter sensors 120. In general, the operating parameter sensor(s) 120 is configured to generate operating parameter data indicative of an operating parameter(s) of the work vehicle 10 during the operation of the work vehicle 10. As will be described below, the data generated by the operating parameter sensor(s) 120 is used to determined when the work vehicle 10 has encountered an obstacle (e.g., a rock, hole, etc.) within the work site.

In some embodiments, the operating parameter(s) may be associated with muddy or slippery portions of the work site. In such embodiments, the operating parameter(s) may be indicative of wheel spin or wheel slip by one or more driven wheels 24 of the work vehicle 10. For example, the operating parameter(s) may be the engine torque of the work vehicle 10, the transmission torque of the work vehicle and/or the rotational speed of the wheels 24. Thus, the operating parameter sensor(s) 120 may correspond to any suitable type(s) of sensing device(s) configured to detect such parameters, such as a torque cell(s), a torque transducer(s), a wheel speed sensor(s), and/or the like.

Moreover, in some embodiments, the operating parameter(s) may be associated with the orientation of the work vehicle 10. In such embodiments, the operating parameter(s) may be indicative of the pitch, roll, and/or yaw of the work vehicle 10. Thus, the operating parameter sensor(s) 120 may correspond to any suitable type(s) of sensing device(s) configured to detect such parameter(s), such as an inertial measurement unit(s), an accelerometer(s), a gyroscope(s), and/or the like.

In addition, the operating parameter(s) may, in some embodiments, be associated with the operation of the earthmoving implement 28 of the work vehicle 10. In such embodiments, the operating parameter(s) may be indicative of the force being exerted on the earthmoving implement 28. Thus, the operating parameter sensor(s) 120 may correspond to any suitable type(s) of sensing device(s) configured to detect such a parameter, such as a strain gauge, a load sensor, a fluid pressure sensor, and/or the like.

Furthermore, in some embodiments, the operating parameter(s) may be associated with manual control of or override of the automated control of the work vehicle. In such embodiments, the operating parameter(s) may be indicative of the inputs to control the work vehicle 10 by the operator, such as the manual adjustments to steering angle and/or the positioning of the earthmoving implement 28. Thus, the operating parameter sensor(s) 120 may correspond to any suitable type(s) of sensing device(s) configured to detect such parameters, such as a linear or rotary potentiometer(s), a Hall effect sensor(s), a fluid pressure sensor(s), and/or the like.

The operating parameter sensor(s) 120 may generate data indicative of any one or any combination of the above-mentioned operating parameter(s). However, in alternative embodiments, the operating parameter sensor(s) 120 may be configured to generate data indicative of any other suitable operating parameter(s) of the work vehicle 10 in addition to or lieu of the above-mentioned operating parameter(s).

Additionally, in some embodiments, the system 100 may include one or more vision-based sensors 122 mounted on otherwise supported on the work vehicle 10. In general, the vision-based sensor(s) 122 may be configured to generate images or other vision-based data depicting the obstacles present within the work site as the work vehicle 10 travels across the work site to perform an earthmoving operation thereon. As will be described below, a computing system may be configured to analyze the generated vision data to identify the type of the obstacles (e.g., whether the obstacle is a rock or a tree).

In general, the vision-based sensor(s) 122 may correspond to any suitable device(s) configured to generate images or other vision-based data depicting the obstacles present within the work site. For example, in one embodiment, the vision-based sensor(s) 122 may correspond to a stereographic camera(s) configured to capture three-dimensional images of the obstacles present within its field of view. In other embodiments, the vision-based sensor(s) 122 may correspond to a monocular camera(s) configured to capture two-dimensional images of the obstacles present within its field of view. However, in alternative embodiments, the vision-based sensor(s) 122 may correspond to any other suitable sensing device(s) configured to capture images or image-like data, such as a LIDAR sensor(s) or a RADAR sensor(s).

Moreover, the system 100 includes a computing system 124 communicatively coupled to one or more components of the work vehicle 10 and/or the system 100 to allow the operation of such components to be electronically or automatically controlled by the computing system 124. For instance, the computing system 124 may be communicatively coupled to the sensors 119, 120, 122 via a communicative link 126. As such, the computing system 124 may be configured to receive data from the sensors 119, 120, 122. Furthermore, the computing system 124 may be communicatively coupled to the devices 102, 104, 110, 116, 118 via the communicative link 126. In this respect, the computing system 124 may be configured to control the operation of the devices 102, 104, 110, 116, 118 to control the operation of the work vehicle 10 such that the work vehicle 10 performs an earthmoving operating on the work site. In addition, the computing system 124 may be communicatively coupled to any other suitable components of the work vehicle 10 and/or the system 100.

In general, the computing system 124 may comprise one or more processor-based devices, such as a given controller or computing device or any suitable combination of controllers or computing devices. Thus, in several embodiments, the computing system 124 may include one or more processor(s) 128 and associated memory device(s) 130 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 130 of the computing system 124 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 130 may generally be configured to store suitable computer-readable instructions that, when implemented by the processor(s) 128, configure the computing system 124 to perform various computer-implemented functions, such as one or more aspects of the methods and algorithms that will be described herein. In addition, the computing system 124 may also include various other suitable components, such as a communications circuit or module, one or more input/output channels, a data/control bus and/or the like.

The various functions of the computing system 124 may be performed by a single processor-based device or may be distributed across any number of processor-based devices, in which instance such devices may be considered to form part of the computing system 124. For instance, the functions of the computing system 124 may be distributed across multiple application-specific controllers or computing devices, such as a navigation controller, an engine controller, a transmission controller, and/or the like.

In addition, the system 100 may also include a user interface 132. More specifically, the user interface 132 may be configured to provide feedback from the computing system 124 (e.g., feedback associated with the locations of obstacles present within the work site) to the operator. As such, the user interface 132 may include one or more feedback devices (not shown), such as display screens, speakers, warning lights, and/or the like, which are configured to provide feedback from the computing system 124 to the operator. As such, the user interface 132 may, in turn, be communicatively coupled to the computing system 124 via the communicative link 126 to permit the feedback to be transmitted from the computing system 124 to the user interface 132. Furthermore, some embodiments of the user interface 132 may include one or more input devices, such as touchscreens, keypads, touchpads, knobs, buttons, sliders, switches, mice, microphones, and/or the like, which are configured to receive inputs from the operator. In one embodiment, the user interface 132 may be mounted or otherwise positioned within the cab 26 of the work vehicle 10. However, in alternative embodiments, the user interface 132 may mounted at any other suitable location.

In one embodiment, the system 100 may include one or more remote device(s) 134. In general, the remote device(s) 134 is any device or equipment that is separate from or otherwise not coupled to or supported on the work vehicle 10. As such, the remote device(s) 134 may correspond to another work vehicle(s) at the work site; a computing device(s) positioned within a work site office, an offsite management off, or at another location remote from the work site; a cloud-based computing device(s); a mobile device(s) (e.g., a laptop, Smartphone, tablet, etc.); and/or the like. Furthermore, a communicative link or interface 136 (e.g., a data bus) may be provided between the remote device(s) 134 and the computing system 124 to allow the remote device(s) 134 and the computing system 124 to communicate via any suitable communications protocol (e.g., Wi-Fi, 3G, 4G, LTE, and/or the like). As will be described below, the feedback associated with the locations of obstacles present within the work site may be transmitted from the computing system 124 to the remote device(s) 134.

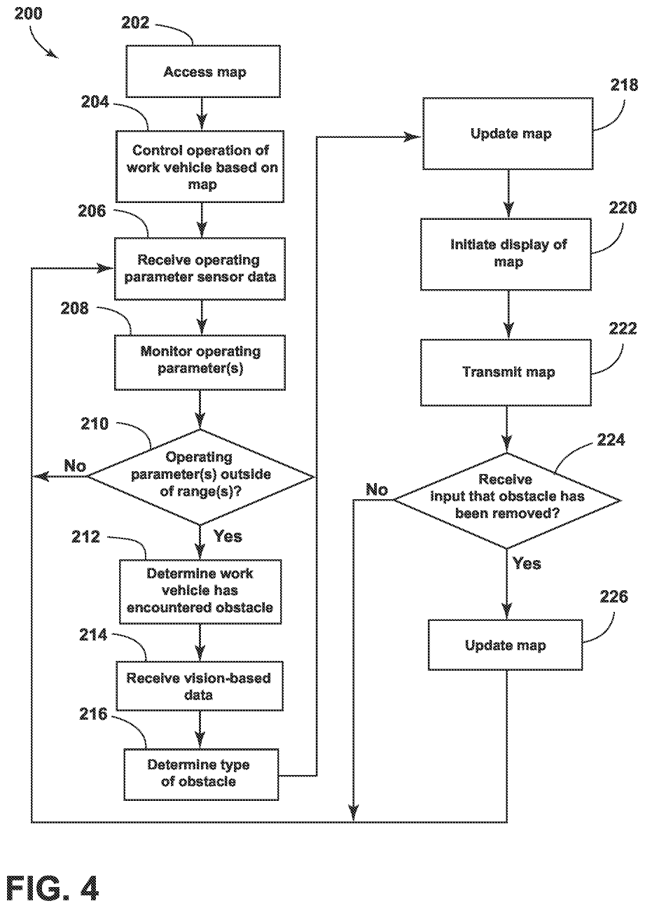

Referring now to FIG. 4, a flow diagram of one embodiment of example control logic 200 that may be executed by the computing system 124 (or any other suitable computing system) for identifying obstacles encountered by a work vehicle within a work site is illustrated in accordance with aspects of the present subject matter. Specifically, the control logic 200 shown in FIG. 4 is representative of steps of one embodiment of an algorithm that can be executed to identify obstacles encountered by a work vehicle within a work site in a manner that reduces the computing resources necessary to identify such obstacles. Thus, in several embodiments, the control logic 200 may be advantageously utilized in association with a system installed on or forming part of a work vehicle to allow for real-time control of identification of obstacles. However, in other embodiments, the control logic 200 may be used in association with any other suitable system, application, and/or the like for identifying obstacles encountered by a work vehicle within a work site.

As shown in FIG. 4, at (202), the control logic 200 includes accessing a map associated with a work site at which a work vehicle is to perform an earthmoving operation. Specifically, before the work vehicle 10 begins an earthmoving operation at a work site (e.g., when forming a roadbed), the computing system 124 is configured to access a map for the work site. For example, in one embodiment, the computing system 124 may access the map from its memory device(s) 130. Alternatively, the computing system 124 may access the map from a remote database server or other remote computing device.

In several embodiments, the map of the work site accessed at (202) may be a cut-fill map. In general, a cut-fill map depicts the material flow needed to transform the current grade or position of one or more surfaces within the work site into a target grade of the surface(s). As such, in some embodiments, the cut-fill map may be a three-dimensional model or final build plan for the work site overlaid on a three-dimensional model of the initial or current topography of the work site. For example, in one embodiment, the cut-fill map may correspond to a heat map indicating high and low spots within the current topography of the work site relative to the final topography of the build site. Thus, the cut-fill map provides an indication of the current topography or grade of the work site, the target topography or grade of the work site, and the material flow necessary to transform the current topography or grade of the work site into the target topography or grade of the work site. However, in alternative embodiments, the accessed map may correspond to any other suitable map type or data structure associated with the work site, such as a design file, a topography map, and/or the like.

Furthermore, at (204), the control logic 200 includes controlling the operation of the work vehicle based on the map to perform the earthmoving operation on the work site. Specifically, as mentioned above, in several embodiments, the computing system 124 may be communicatively coupled to the actuators 102, 104, 110 of the work vehicle 10, the engine 116 of the work vehicle 10, and/or the transmission 118 of the work vehicle 10 via the communicative link 126. In this respect, the computing system 124 may be configured to transmit control signals of the actuators 102, 104, 110 instructing the actuators 102, 104, 110 to adjust position of the earthmoving implement 28 based on the map accessed at (202) such that the earthmoving operation is executed. Additionally, or alternatively, the computing system 124 may be configured to control the operation the engine 116, the transmission 118, and/or other devices of the work vehicle 10, such as its steering actuator (not shown), to facilitate performance of the earthmoving operation.

Additionally, at (206), the control logic 200 includes receiving operating parameter sensor data indicative of one or more operating parameters of the work vehicle during the performance of the earthmoving operation. Specifically, as mentioned above, in several embodiments, the computing system 124 may be communicatively coupled to the operating parameter sensor(s) 120 via the communicative link 126. In this respect, as the work vehicle 10 performs the earthmoving operation on the work site, the computing system 124 may receive operating parameter data from the operating parameter sensor(s) 120. Such data may, in turn, be indicative of one or more operating parameters of the work vehicle 10. As will be described below, that operating parameter data received at (206) is used to determine when the work vehicle 10 has encountered an obstacle within the work site.

Any suitable operating parameter of the work vehicle 10 and/or combination of operating parameters of the work vehicle 10 may be received at (206). In general, the operating parameter(s) is directly indicative of the operation or performance of the work vehicle 10. For example, in some embodiments, the operating parameter(s) may be indicative of wheel spin or wheel slip by one or more driven wheels 24 of the work vehicle 10. For example, the operating parameter(s) may be the engine torque of the work vehicle 10, the transmission torque of the work vehicle 10, and/or the speed of the wheels 24. Moreover, in some embodiments, the operating parameter(s) may be associated with the orientation of the work vehicle 10, such as its pitch, roll, and/or yaw. Furthermore, in some embodiments, the operating parameter(s) may be indicative of the operation of the earthmoving implement 28 of the work vehicle 10, such as the force being exerted on the earthmoving implement 28. Additionally, in some embodiments, the operating parameter(s) may be indicative of manual control of or override of the automated control of the work vehicle 10, such as manual adjustments to steering angle and/or the positioning of the earthmoving implement 28.

Moreover, at (208), the control logic 200 includes monitoring the operating parameter(s) of the work vehicle as the earthmoving operation is being performed based on the received operating parameter sensor data. Specifically, in several embodiments, the computing system 124 may be configured to analyze the operating parameter sensor data received at (206) to monitor the operating parameter(s) of the work vehicle 10 as the earthmoving operation is being performed. As will be described below, the monitored operating parameter(s) is used to determine when the work vehicle 10 has encountered an obstacle within the work site.

In addition, at (210), the control logic 200 includes comparing the monitored operating parameter(s) to an associated range(s). Specifically, in several embodiments, the computing system 124 may be configured to compare the value of each operating parameter monitored at (208) to an associated range of values. Thereafter, when the monitored operating parameter(s) are within the associated range(s), the work vehicle 10 is not currently encountering an obstacle within the work site. In such instances, the control logic 200 returns to (206). Conversely, when one or more of the monitored operating parameter(s) fall outside of the associated range(s), the control logic 200 proceeds to (212).

As shown in FIG. 4, at (212), when one or more of the monitored operating parameter(s) falls outside of the associated range(s), the control logic 200 includes determining that the work vehicle has encountered an obstacle within the work site. As will be described below, when one or more of the monitored operating parameter(s) fall outside of the associated range(s), an obstacle may be interfering with the normal operation of the work vehicle 10. As such, in several embodiments, the computing system 124 may be configured to determine that the work vehicle 10 has encountered an obstacle within the work site when one or more of the monitored operating parameter(s) falls outside of the associated range(s) at (210). Thereafter, the computing system 124 may determine the location of the obstacle based on the location data generated by the location sensor 119.

In general, any suitable obstacle may be detected based on the monitored operating parameter(s) of the work vehicle 10. For example, the obstacle may be muddy or slippery work site conditions, a rock or other impediment, a hole or divot, and/or the like.

As mentioned above, in some embodiments, the monitored operating parameter(s) may include the engine torque and/or transmission torque of the work vehicle 10. For example, when the monitored engine torque and/or the transmission torque remain generally constant as the ground speed of the work vehicle 10 decreases, the work vehicle 10 may be dragging a rock or other impediment within the work site. Conversely, when the monitored engine torque and/or the transmission torque drop outside of the associated range(s), the driven wheels 24 of the work vehicle 10 may be slipping. Thus, when the engine torque and/or transmission torque of the work vehicle 10 fall outside of the associated range(s), the work vehicle 10 has likely encountered an obstacle.

Furthermore, as mentioned above, in some embodiments, the monitored operating parameter(s) may include the wheel speed of the driven wheels 24 of the work vehicle 10. For example, when the monitored wheel speed of the wheels 24 increases as the ground speed of the work vehicle 10 remains generally constant, the wheels 24 may be slipping. Such slipping may, in turn, be caused by muddy or slippery work site conditions. Thus, when the wheel speed of the work vehicle 10 falls outside of the associated range(s), the work vehicle 10 has likely encountered an obstacle.

Additionally, as mentioned above, in some embodiments, the monitored operating parameter(s) may include the orientation of the work vehicle 10, such as its pitch, roll, and/or yaw. For example, when a rock or other impediment is being dragged by the earthmoving implement 28, a divot or trench may be formed in the soil behind the work vehicle 10. When one of the wheels 24 falls into the divot/trench, the work vehicle 10 may be pitched to one side. Thus, when the pitch, roll, and/or yaw of the work vehicle 10 fall outside of the associated range(s), the work vehicle 10 has likely encountered an obstacle.

Moreover, as mentioned above, in some embodiments, the monitored operating parameter(s) may include the force being exerted on the earthmoving implement 28. For example, when a rock or other impediment is being dragged by the earthmoving implement 28, force being exerted on the earthmoving implement 28 increases. Thus, when the force being exerted on the earthmoving implement 28 falls outside of the associated range(s), the work vehicle 10 has likely encountered an obstacle.

In addition, as mentioned above, in some embodiments, the monitored operating parameter(s) may include manual control of or override of the automated control of the work vehicle 10. For example, when the operator manually adjusts steering angle and/or the position of the earthmoving implement 28, such adjustment may be made to avoid obstacles within the work site, such as rocks, muddy areas, holes/divots, and/or the like. Thus, when manual control of or override of the automated control of the work vehicle 10 occurs, the work vehicle 10 has likely encountered an obstacle.

In one embodiment, minor adjustments control inputs or adjustments from the operator may not be indicative of the presence of obstacles. Thus, in such an embodiment, the computing system 124 may determine the magnitude of a manual operator adjustment and compare the determined magnitude to a threshold value. When the determined magnitude is at or below the threshold value, operator adjustment may be sufficiently minor such that it is not indicative of an obstacle. Conversely, when the determined magnitude exceeds the threshold value, operator adjustment may be sufficient to be indicative of an obstacle. In such instances, the computing system 124 may determine that the work vehicle 10 has encountered the obstacle.

As shown in FIG. 4, at (214), the control logic 200 includes receiving vision-based data depicting the obstacle encountered by the work vehicle. Specifically, as mentioned above, in several embodiments, the computing system 124 may be communicatively coupled to the vision-based sensor(s) 122 via the communicative link 126. In this respect, as the work vehicle 10 performs the earthmoving operation on the work site, the computing system 124 may receive vision-based sensor data from the vision-based sensor(s) 122. Such data may, in turn, depicting the obstacle that was determined to be present at (212).

Furthermore, at (216), the control logic 200 includes identifying the type of the obstacle encountered by the work vehicle based on the received vision-based data. Specifically, in several embodiments, the computing system 124 is configured to analyze the vision-based data received at (214) to identify the type or categories of the obstacle that was determined to be present at (212). The type of the obstacle may, in turn, be a general identification of the obstacle, such as a rock, a tree, a muddy portion of the work site, etc. In some embodiments, (214) and (216) may be omitted.

Additionally, at (218), the control logic 200 includes updating the map to identify the location of the obstacle within the work site on the map. Specifically, in several embodiments, the computing system 124 may be configured to update the map (e.g., the map accessed at (202) or the most recently updated map) to identify the location of the obstacle determined to be present at (212) within the work site on the map. For example, the computing system 124 may add a warning indicator (e.g., a flag or other icon) to the map at the location where the obstacle was determined to be present. In embodiments in which the control logic 200 includes (214) and (216), the warning indicator may be a graphic or image of the determined type of the obstacle (e.g., an image of a rock, a tree, mud, etc.).

Moreover, at (220), the control logic 200 includes initiating display of the map to an operator of the work vehicle. Specifically, as mentioned above, in several embodiments, the computing system 124 may be communicatively coupled to the user interface 132 via the communicative link 126. In this respect, the computing system 124 may transmit control signals to the user interface 132 via the communicative link 126. Such control signals may, in turn, instruct the user interface 132 to display the updated map to the operator such that the location(s) of any obstacle(s) determined to be present within the work site is identified with a warning indicator(s) on the user interface 132. This allows the operator to easily visualize the location(s) of the obstacle(s) present within the work site.

In addition, at (222), the control logic 200 includes transmitting the map to one or more remote device 134. Specifically, as mentioned above, in several embodiments, the computing system 124 may be communicatively coupled to the remote device(s) 134 via the communicative link 136. In this respect, the computing system 124 may transmit the updated map to the remote device(s) 134 via the communicative link 136. This allows personnel at other locations remote to the work vehicle 10 (e.g., operators of other vehicles, work site office personnel, offsite management, etc.) to view the location(s) of the obstacle(s) present within the work site as the earthmoving operation is being performed.

As shown in FIG. 4, at (224), the control logic 200 includes determining whether an input from the operator of the work vehicle indicating that the obstacle has been removed was received. Specifically, when the operator determines that an identified obstacle within the work site has been removed (e.g., after the operator or other personnel have removed the obstacle or work site conditions have improved), the operator may provide an input to the user interface 132. Such input is, in turn, indicative of the operator's determination that the obstacle has been removed from the work site. Thereafter, the operator input may be transmitted from the user interface 132 to the computing system 124 via the communicative link 126. Alternatively, the computing system 124 may receive the input the remote device(s) 218 (e.g., via the communicative link 136). When no such input has been received at (224), the control logic 200 returns to (206). Conversely, when such an input has been received at (224), the control logic 200 proceeds to (226).

Furthermore, at (226), upon receipt of the input, the control logic 200 includes updating the map to remove the warning indicator. Specifically, in several embodiments, upon receipt of the operator input at (224), the computing system 124 may be configured to update the map (e.g., the most recently updated map) to remove the warning indicator corresponding to the obstacle that has been removed from the work site. The map updated at (226) may then displayed on the user interface 132 (e.g., by refreshing the screen) and/or transmitted to the remote device(s) 134. Thereafter, the control logic 200 returns to (206).

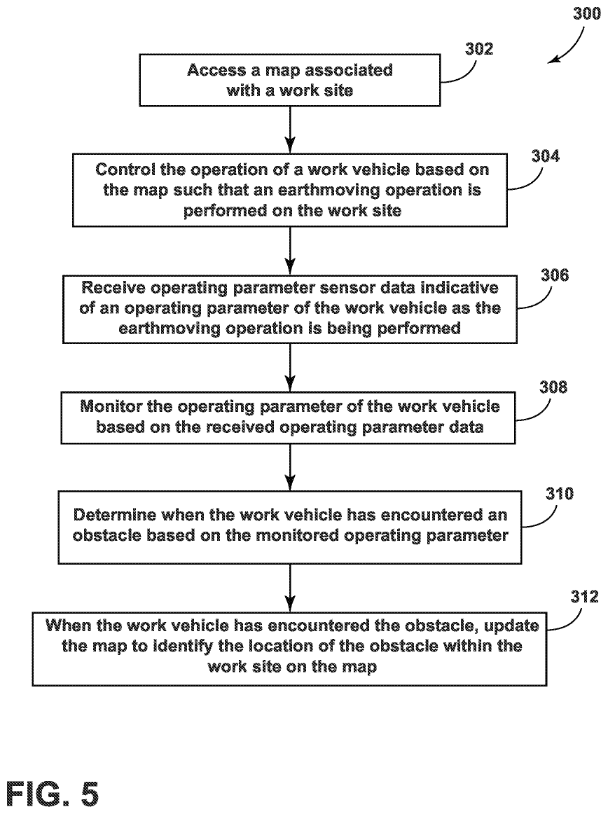

Referring now to FIG. 5, a flow diagram of one embodiment of a method 300 for identifying obstacles encountered by a work vehicle within a work site is illustrated in accordance with aspects of the present subject matter. In general, the method 300 will be described herein with reference to the work vehicle 10 and the system 100 described above with reference to FIGS. 1-4. However, it should be appreciated by those of ordinary skill in the art that the disclosed method 300 may generally be implemented with any work vehicle having any suitable vehicle configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (302), the method 300 includes accessing, with a computing system, a map associated with a work site. For instance, as described above, the computing system 124 may be configured to access a map associated with a work site (e.g., from its memory device(s) 130). The map, in turn, depicts the material flow for transforming a current grade of a surface of the work site into a target grade of the surface.

Additionally, at (304), the method 300 includes controlling, with the computing system, the operation of a work vehicle based on the map such that an earthmoving operation is performed on the work site. For instance, as described above, the computing system 124 may be configured to control the operation of the work vehicle 10 (e.g., its engine 116, its transmission 118, and/or its actuator(s) 102, 104, 110) based on the accessed map such that an earthmoving operation is performed on the work site.

Moreover, as shown in FIG. 5, at (306), the method 300 includes receiving, with the computing system, operating parameter sensor data indicative of an operating parameter of the work vehicle as the earthmoving operation is being performed. For instance, as described above, the computing system 124 may be configured to receive operating parameter sensor data from the operating parameter sensor(s) 120 as the earthmoving operation is being performed. Such data is, in turn, indicative of one or more operating parameters of the work vehicle 10.

Furthermore, at (308), the method 300 includes monitoring, with the computing system, the operating parameter of the work vehicle based on the received operating parameter data. For instance, as described above, the computing system 124 may be configured to monitor the operating parameter(s) of the work vehicle 10 based on the received operating parameter data.

In addition, as shown in FIG. 5, at (310), the method 300 includes determining, with the computing system, when the work vehicle has encountered an obstacle based on the monitored operating parameter. For instance, as described above, the computing system 124 may be configured to determine when the work vehicle 10 has encountered an obstacle based on the monitored operating parameter(s).

Moreover, at (312), when the work vehicle has encountered the obstacle, the method 300 includes updating, with the computing system, the map to identify the location of the obstacle within the work site on the map. For instance, as described above, when the work vehicle 10 has encountered the obstacle, the computing system 124 may be configured to update the map to identify the location of the obstacle within the work site on the map.

It is to be understood that the steps of the control logic 200 and the method 300 are performed by the computing system 124 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 124 described herein, such as the control logic 200 and the method 300, is implemented in software code or instructions which are tangibly stored on a tangible computer readable medium. The computing system 124 loads the software code or instructions via a direct interface with the computer readable medium or via a wired and/or wireless network. Upon loading and executing such software code or instructions by the computing system 124, the computing system 124 may perform any of the functionality of the computing system 124 described herein, including any steps of the control logic 200 and the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A work vehicle, comprising:
a frame;
an earthmoving implement supported on the frame, the earthmoving implement configured to move material as the work vehicle travels across a surface within a work site;
an operating parameter sensor configured to generate operating parameter data indicative of an operating parameter of the work vehicle; and
a computing system communicatively coupled to the operating parameter sensor, the computing system configured to:
access a map associated with the work site;
control an operation of the work vehicle based on the map such that an earthmoving operation is performed on the work site;
monitor the operating parameter of the work vehicle as the earthmoving operation is being performed based on the operating parameter data generated by the operating parameter sensor;
determine when the work vehicle has encountered an obstacle based on the monitored operating parameter; and
when the work vehicle has encountered the obstacle, update the map to identify a location of the obstacle within the work site on the map.

2. The work vehicle of claim 1, wherein the operating parameter comprises at least one of an engine torque of the work vehicle, a transmission torque of the work vehicle, or a wheel speed.

3. The work vehicle of claim 1, wherein the operating parameter comprises a work vehicle orientation parameter.

4. The work vehicle of claim 1, wherein the operating parameter comprises a force being exerted on the earthmoving implement.

5. The work vehicle of claim 1, wherein the operating parameter comprises a manual operator adjustment to the operation of the work vehicle.

6. A system for identifying obstacles encountered by a work vehicle within a work site, the system comprising:
an operating parameter sensor configured to generate operating parameter data indicative of an operating parameter of the work vehicle; and
a computing system communicatively coupled to the operating parameter sensor, the computing system configured to:
access a map associated with the work site;
control an operation of the work vehicle based on the map such that an earthmoving operation is performed on the work site;
monitor the operating parameter of the work vehicle as the earthmoving operation is being performed based on the operating parameter data generated by the operating parameter sensor;
determine when the work vehicle has encountered an obstacle based on the monitored operating parameter; and
when the work vehicle has encountered an obstacle, update the map to identify a location of the obstacle within the work site on the map.

7. The system of claim 6, wherein, when determining when the work vehicle has encountered the obstacle, the computing system is configured to:
compare the monitored operating parameter to a predetermined range; and
determine that the work vehicle has encountered the obstacle when the monitored operating parameter falls outside of the predetermined range.

8. The system of claim 6, wherein the operating parameter comprises at least one of an engine torque of the work vehicle, a transmission torque of the work vehicle, or a wheel speed of the work vehicle.

9. The system of claim 6, wherein the operating parameter comprises a work vehicle orientation parameter.

10. The system of claim 6, wherein the operating parameter comprises a force being exerted on the earthmoving implement.

11. The system of claim 6, wherein the operating parameter comprises a manual operator adjustment to the operation of the work vehicle.

12. The system of claim 11, wherein, when determining when the work vehicle has encountered the obstacle, the computing system is configured to:
determine a magnitude of the manual operator adjustment;
compare the determined magnitude to a threshold value; and
determine that the work vehicle has encountered the obstacle when the determined magnitude exceeds the threshold value.

13. The system of claim 6, wherein the computing system is further configured to initiate display of the map to an operator of the work vehicle such that the location of the obstacle within the work site is identified with a warning indicator on the displayed map.

14. The system of claim 13, wherein the computing system is further configured to:
receive an input from an operator of the work vehicle indicating that the obstacle has been removed; and
upon receipt of the input, update the map to remove the warning indicator.

15. The system of claim 6, further comprising:
a vision-based sensor configured to generate vision-based data depicting the obstacle encountered by the work vehicle, the vision-based sensor being communicatively coupled to the computing system,
wherein the computing system is further configured to identify a type of the obstacle encountered by the work vehicle based on the vision-based data generated by the vision-based sensor.

16. The system of claim 6, wherein, after updating the map to identify the location of the obstacle, the computing system is further configured to transmit the map to a remote device.

17. A method for identifying obstacles encountered by a work vehicle within a work site, the method comprising:
accessing, with a computing system, a map associated with the work site;
controlling, with the computing system, an operation of the work vehicle based on the map such that an earthmoving operation is performed on the work site;
receiving, with the computing system, operating parameter sensor data indicative of an operating parameter of the work vehicle as the earthmoving operation is being performed;
monitoring, with the computing system, the operating parameter of the work vehicle based on the received operating parameter data;
determining, with the computing system, when the work vehicle has encountered an obstacle based on the monitored operating parameter; and
when the work vehicle has encountered the obstacle, updating, with the computing system, the map to identify a location of the obstacle within the work site on the map.

18. The method of claim 17, wherein the operating parameter comprises at least one of an engine torque of the work vehicle, a transmission torque of the work vehicle, or a wheel speed.

19. The method of claim 17, wherein the operating parameter comprises a work vehicle orientation parameter.

20. The method of claim 17, wherein the operating parameter comprises a manual operator adjustment to the operation of the work vehicle.
